(19) United States
(12) Patent Application Publication
(10) Pub. No.: US 2011/0161834 A1
(43) Pub. Date: Jun. 30, 2011

(54) Systems and Methods for Restoring and Recreating a Live On-Line Session

(75) Inventors: Shahin Shadfar, Houston, TX (US); Prabhu Tamilarasan, Katy, TX (US)

(73) Assignee: omNovia Technology, Inc., Houston, TX (US)

(21) Appl. No.: 12/871,199

(22) Filed: Aug. 30, 2010

Related U.S. Application Data
(60) Provisional application No. 61/291,739, filed on Dec. 31, 2009.

(51) Int. Cl. G06F 3/048; G06F 15/16

(52) U.S. Cl. 715/753

(57) ABSTRACT

A system and method for restoring and recreating a live, on-line session are disclosed. The method instantiates a virtual room on a server for an on-line session, in which one or more participating client computers may connect to the server and enter the virtual room to participate in the on-line session, retrieves a recording of an original on-line session, in which the recording includes a recorded state and a recorded timeline of events of the original on-line session, and restores the recorded state of the original on-line session, in which the restoring sets a state of the virtual room to the recorded state of the original on-line session. The method also begins playback of the recorded timeline of events, steps through the recorded timeline of events, receives interactive responses to events on the recorded timeline of events, in which the receiving receives interactive responses from the one or more participating client computers, and stores the interactive responses.

### RELATED APPLICATIONS

This application claims the priority of U.S. Provisional Application, 61/291,739, entitled “Systems and Methods for Restoring and Recreating a Live Presentation pr Meeting Session,” and filed Dec. 31, 2009, which is hereby incorporated in its entirety by reference.

### BACKGROUND

One important feature in any web conferencing system is a record and replay facility. It is necessary for many businesses to archive their live online presentations and meetings so that the archived presentations and meetings are available for review at a later time.

Such archiving is particularly useful for those who missed the live event or if an organization is required, e.g., by law or regulation, to keep a recording of any public presentation. A live web conference session includes presentation materials, desktop or application sharing, voice, video, pre-recorded movies as well as interactions with participants through chat, instant surveys, file sharing etc. An ideal replay of a recorded session would reproduce an experience for the viewer as close as possible to the live session participant's experience.

Existing technology consists of recording the screen of the computer during the live presentation or meeting including the playing audio. The outcome of this recording is a standard format movie. The formats may include AVI, WMV, SWF, etc.

The recorded movie of an online training session is similar to a movie of a live classroom and can show the experience of the viewer on the computer on which the session was recorded.

There are a number of disadvantages to such existing technologies:
Reviewing a recorded movie does not create or enable any interactivity.
The recorded experience is very different from the live experience. For example: during the live presentation, the presenter asks participants to take a survey or asks participants to download a document from a shared folder environment in the virtual meeting room. While reviewing a movie, the viewer is not able to click anywhere on the screen to take the survey or click anywhere to download any files.
At the time of recording, a “recorder” application runs on the Presenter's or another Participant's computer. This uses CPU (computer power) and may interfere with other applications running on the computer, consequently affecting the performance of the computer.
The recorded movies generally have a very large size in terms of memory usage. Uploading the recorded movie, to a server, in order to make it available to others, may take time.
The recorded movie is usually compressed to reduce the file size, which leads to loss of image and audio resolution and quality.
In order to view the recorded movie, the viewer needs to download a large file onto his/her computer, which can slow down the process.
Different people have different computer screen resolutions (number of pixels making up their screens). A pre-recorded movie cannot adapt ideally to different screen sizes since it was recorded on one particular computer.

In summary, the current solutions problems are:
Difficult process to record a live web based presentation
Lack of interactivity when watching a flat recorded movie
Lower image and audio quality compared to original live presentation

### SUMMARY

These and other disadvantages are overcome by a method for restoring and recreating a live, on-line session. The method instantiates a virtual room on a server for an on-line session, in which one or more participating client computers may connect to the server and enter the virtual room to participate in the on-line session, retrieves a recording of an original on-line session, in which the recording includes a recorded state and a recorded timeline of events of the original on-line session, and restores the recorded state of the original on-line session, in which the restoring sets a state of the virtual room to the recorded state of the original on-line session. The method also begins playback of the recorded timeline of events, steps through the recorded timeline of events, receives interactive responses to events on the recorded timeline of events, in which the receiving receives interactive responses from the one or more participating client computers, and stores the interactive responses.

These and other disadvantages are also overcome by a method for restoring and recreating a live, on-line session. The method instantiates a virtual room on a server for an original on-line session, in which one or more participating client computers may connect to the server and enter the virtual room to participate in the original on-line session, begins the on-line session activity, records the on-line session activity, in which the recording creates a recording of the on-line session, and closes the virtual room for the original on-line session. The method receives a request for a replay of the original on-line session, in response to the received request, instantiates a virtual room on a server for a restored on-line session, in which one or more participating client computers may connect to the server and enter the virtual room to participate in the restored on-line session, retrieves the recording of the original on-line session, in which the recording includes a recorded state and a recorded timeline of events of the original on-line session, and restores the recorded state of the original on-line session, in which the restoring sets a state of the virtual room to the recorded state of the original on-line session. The method also begins playback of the recorded timeline of events, steps through the recorded timeline of events, receives interactive responses to events on the recorded timeline of events, in which the receiving receives interactive responses from the one or more participating client computers, and stores the interactive responses.

These and other disadvantages are also overcome by a computer readable medium including instructions for restoring and recreating a live, on-line session. The instructions instantiate a virtual room on a server for an on-line session, in which one or more participating client computers may connect to the server and enter the virtual room to participate in the on-line session, retrieve a recording of an original on-line session, in which the recording includes a recorded state and a recorded timeline of events of the original on-line session, and restore the recorded state of the original on-line session, in which the restoring sets a state of the virtual room to the recorded state of the original on-line session. The instructions also begin playback of the recorded timeline of events, step through the recorded timeline of events, receive interactive responses to events on the recorded timeline of events, in which the receiving receives interactive responses from the one or more participating client computers, and store the interactive responses.

These and other disadvantages are also overcome by a system for restoring and recreating a live, on-line session. The system includes a server computer that include one or more memories and one or more processors. The one or more memories includes instructions executed by the one or more processors for restoring and recreating a live, on-line session. The instructions instantiate a virtual room on a server for an on-line session, in which one or more participating client computers may connect to the server and enter the virtual room to participate in the on-line session, retrieve a recording of an original on-line session, in which the recording includes a recorded state and a recorded timeline of events of the original on-line session, and restore the recorded state of the original on-line session, in which the restoring sets a state of the virtual room to the recorded state of the original on-line session. The instructions also begin playback of the recorded timeline of events, step through the recorded timeline of events, receive interactive responses to events on the recorded timeline of events, in which the receiving receives interactive responses from the one or more participating client computers, and store the interactive responses.

### DESCRIPTION OF THE DRAWINGS

The detailed description may refer to the following drawings, wherein like numerals refer to like elements, and wherein:

FIG. 1 is a block diagram illustrating an embodiment of a system for restoring and recreating a live online session.

FIG. 2 is a flowchart illustrating an embodiment of a method for restoring and recreating a live online session.

FIG. 3 is diagram illustrating an embodiment of a recording file of an embodiment of a system and method for restoring and recreating a live online session.

FIG. 4 is a diagram illustrating an embodiment of a timeline of an embodiment of a system and method for restoring and recreating a live online session.

FIG. 5 is a diagram illustrating an embodiment of a replay workflow of an embodiment of a system and method for restoring and recreating a live online session.

FIG. 6 is a diagram illustrating an embodiment of a timeline with fast-forwarding in an embodiment of a system and method for restoring and recreating a live online session.

FIG. 7 is flowchart illustrating an embodiment of a method for restoring and recreating a live online session.

FIG. 8 is a block diagram illustrating exemplary hardware components of an embodiment of a system for restoring and recreating a live online session.

### DETAILED DESCRIPTION

Described herein are embodiments of a system and method for recreating and restoring a live online session. The live online session may be, e.g., presentation, meeting, webinar or similar session. Such sessions typically involve audio, video, slide, graphic, text, document, file and other elements (e.g., such a session may be a video conference with presentation slides and a narrative speaker). Embodiments of the system and method, which may be referred to as “Recast” technology, bring a new outlook to web conference record and replay solutions. Instead of creating a flat movie file, embodiments described herein record enough information, e.g., on a server, to literally recreate or restore such a conference, presentation, meeting, etc. session exactly the way the session happened when live.

A live presentation or meeting session is conducted in a virtual meeting room environment. When recording starts, a system server may begin to ‘memorize’ every step of the presentation or meeting session with the exact time of each step, as well as the state of the virtual room environment. At the time of replay, the viewer re-enters the virtual room environment in which the session took place and the server begins to reproduce every step of the original presentation, providing the viewer the exact same experience as the live session.

### SIMPLE EXAMPLE

### Example 1

5 seconds after the beginning of the recording, a message is posted in a chat area of the virtual room environment.
2.5 seconds later a Microsoft PowerPoint presentation gets loaded.
6 seconds later the slide numbers changes from 1 to 2.

10 seconds later a presenter starts talking.
5 seconds later the presenter pops up a survey, which the (recorded session) viewer can take.
20 seconds later the presenter asks viewers via voice to download a brochure by clicking a link in the virtual room. This can also be done by the (recorded session) viewer.

The server can faithfully reproduce all these steps with the accompanying materials such as recorded voice stream or PowerPoint presentation.

Among the advantages of embodiments described herein:
The replay of a session remains interactive. For example, the viewer can take a survey or click and download a document from the shared folder. The survey results (from the original session) are updated to include the recorded session viewer's input.
The experience is identical to the live session.
Recording happens on the server. This makes life easier for the presenters and does not use any CPU (computer power).
The outcome is significantly smaller in memory size than a traditional recording.
There is no large file to upload or download.
The replay adapts to the viewer screen size.
There is absolutely no loss in resolution or quality.
The recorded session can be played On-Demand (for 1 viewer) or in a Group Mode (for a new group of viewers). In the latter mode, live presenters/moderators can speak over the recording and answer potential questions the audience may have while the recorded session is still playing.

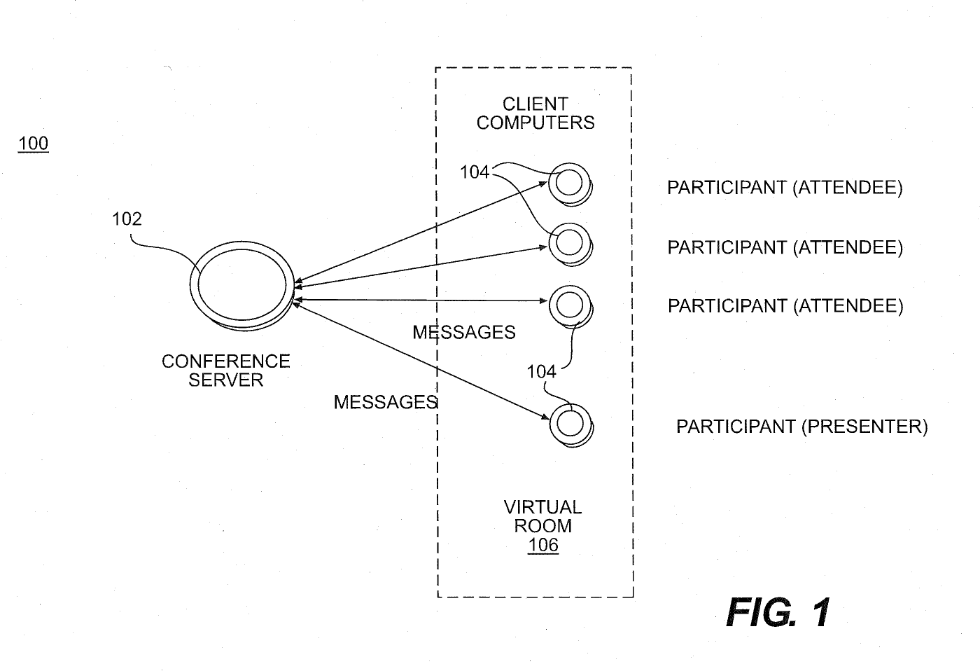

With reference now to FIG. 1 shown is an embodiment of system 100 for restoring and recreating a live online session. Embodiment of system 100 may include server 102 (labeled “conference server”) and clients 104 (labeled participants). Server 102 may include application(s) to instantiate a web conference session or virtual room 106 into which clients 104 log in to and enter to participate in online web conference session. Clients 104 may include computers connected to server 102 in a client-server relationship that session participants use to connect to virtual rooms and participate in live online web conference sessions. Client 104 computers may include application(s) to connect with server 102, log in to and enter the virtual room and participate in the online web conference sessions. Participants may include presenters, moderators, administrators, meeting participants, and attendees. Clients 104 are described in more detail below.

A virtual room 106 is an online session into which participants log in and through which participants receive, listen and view audio and/or video feeds from other participants (e.g., presenters), presentation slides (e.g., MS Powerpoint™ slides) and other aspects of online meetings, presentations or other such sessions. A virtual room 106 may appear as a window on client 104 displays. Participants may also interact with online session through virtual room 106 and send messages to other participants through server 102, e.g., entering questions, comments and other chat inputs, responding to survey or other questions, or otherwise entering input through window on client 104. When clients 104 are logged into a virtual room 106, participants at clients 104 may see representation of presenter and/or other participants that have entered virtual room (unless privacy option is selected to hide other participants). Representation of participants may simply be a listing of participants' names. Session moderators and/or administrators, responsible for smooth running of meeting/presentation and online session and operation of virtual room 106, may also be represented in virtual room 106.

With continued reference to FIG. 1, server 102 may also record the live activities or events of the online session and build a detailed time-line of the online session and these events or activities. As discussed in detail below, the server 102 may also save the state of the virtual room 106 at appropriate times. Using the recorded activities and events, the time-line and the saved state, the server 102 may also recreate and replay the recorded activities and events, restoring the online session for later participants.

The following describes the “live activities” that take place in embodiments in more detail. Understanding the live activities is necessary for applying the technique to record these activities. The recording technique followed by the replay methods used in embodiments described herein follow the description of the live activities. One of skill in the art will understand that variations of the below are possible within the scope described herein.

Live Activities

Although a web conference session may be handled by multiples servers simultaneously in case of events with a large number of participants or with geographically dispersed participants, the following description assumes there is one server only for sake of simplicity.

A web conference session or ‘virtual room’ begins with the authentication of participants, regrouped as presenters, moderators and attendees by a ‘gateway’ web server. Once authenticated, the participants may be channeled to a different server, or remain on same server, which ‘hosts’ the live online session. As shown in FIG. 1, all participants (on clients 104) may be connected to a ‘conference server’ 102 after authentication. Once connected, clients 104 can send and receive messages to/from the server 102. The term ‘message,’ as used herein, may refer to any signal sent or received by the client 104 or conference server 102. The term ‘text message’ is used if referencing a chat text message typed by a participant.

An example of message is a signal sent to clients 104 to load a slide show (Microsoft PowerPoint) presentation. The signal may be sent automatically at a certain, pre-programmed point in the session by the server 102, or as directed or by the presenter or session moderator/administrator. Once received by clients 104, the clients 104 automatically start downloading and displaying a slide show. Another message example is the signal to change the participants' view from Slide Show to a White Board. The clients 104 will automatically switch to white board when the message is received.

Each activity or event, such as loading a slide show, is achieved through one or multiple ‘steps’ on the conference server 102 and may result in one or more messages being exchanged with participants at clients 104.

With continuing reference to FIG. 1, to further illustrate an activity, a presenter “A” at a client 104 wants to load a slide show “X” for all participants, at other clients 104, and then go to slide number 5. In this example, it is assumed that the slide show has already been prepared and is ready on the server 102 to be shown.

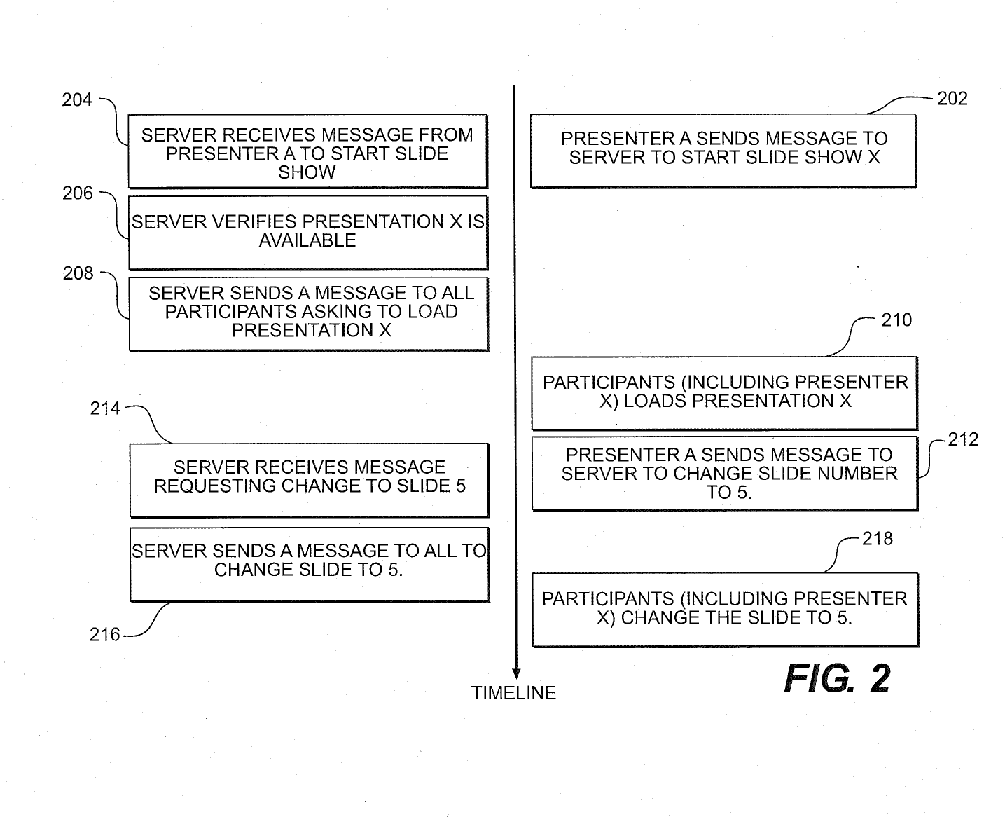

With reference now to FIG. 2, shown are is an embodiment of a method 200 for presenting a presentation. Method 200 is executed on the server 102 as well as clients 104. Steps of method 200 performed on the server 102 are shown on the left side of FIG. 2, while steps performed on clients 104 are shown on the right side of FIG. 2. Sometime prior to start of method 200, virtual room for online web conference session with client 104 participants is instantiated and presenter's client 104 sends presentation, e.g., slide show X, to server 102. Server 102 receives presentation and stores presentation (e.g., in local storage device). Presenter sends message from client 104 to server 102 to start presentation, block 202. Server 102 receives message from client 104 (presenter) requesting starting of presentation, block 204. Server 102 verifies presentation is available, block 206. For example, server 102 may check local storage device, such as a connected database, to verify presentation is stored in device. Server 102 sends message to all clients 104 asking clients 104 to load the presentation, block 208. The message will typically include a link to the presentation file on the server. Participant clients 104 load presentation by receiving presentation, storing the presentation in memory and starting presentation so that it is displayed on participant client 104 displays, block 210. Presenter sends message from client 104 to server 102 requesting slide of presentation be changed, e.g., to slide number 5, block 212. Server 102 receives the message, block 214, and sends message to all participant clients 104 to change slide of presentation, e.g., to slide number 5, block 216. Participant clients 104 change the displayed slide of presentation to requested slide, e.g., slide number 5, block 218.

Conference server 102 retains the ‘state’ of the virtual room 106 by keeping track of the above blocks 202-218 and by accumulating the impacts of the steps. The state of the virtual room 106 is critical since server 102 must communicate it to all new virtual room entrants (all new clients 104 logging in to virtual room and joining online web conference session). In the example above, when a new participant connects to the virtual room 106, server 102 sends one or more messages to new client 104 communicating the state of the virtual room 106. As a consequence client 104 automatically loads the presentation, e.g., slide show X, and goes to the requested slide, e.g., slide number 5, and is then ready to receive new messages like other participants.

The following is a more complete example of the state of the virtual room 106, which is retained in a server ‘object’.
Room is in private mode, meaning that attendees cannot read other attendees' text messages
Presentation X is loaded
Presentation X slide number is 5
A background music Y is playing
There are 6 files in a Shared Folder
Presenter X is talking (so there is a voice stream X playing)
Presenter Z is typing a message
. . .

As a summary “Live Activities” are achieved through different steps and it is noteworthy that conference server 102 has at any time an object with the state of the conference (the state of the virtual room) ready to pass to new participants.

Recording

Embodiments described herein provide a completely different approach to the recording of a presentation. Instead of recording the outcome of the presentation as it is shown on a participants screen in a movie format, embodiments of the systems and methods for recreating and restoring a live presentation or meeting session track and record a timeline with every step of the presentation.

When a presenter decides to start recording the session, the virtual room is already in a certain state, as described above. Therefore, the recording first records the initial state of the room and then creates a timeline with the details of every step until the presenter decides to stop the recording.

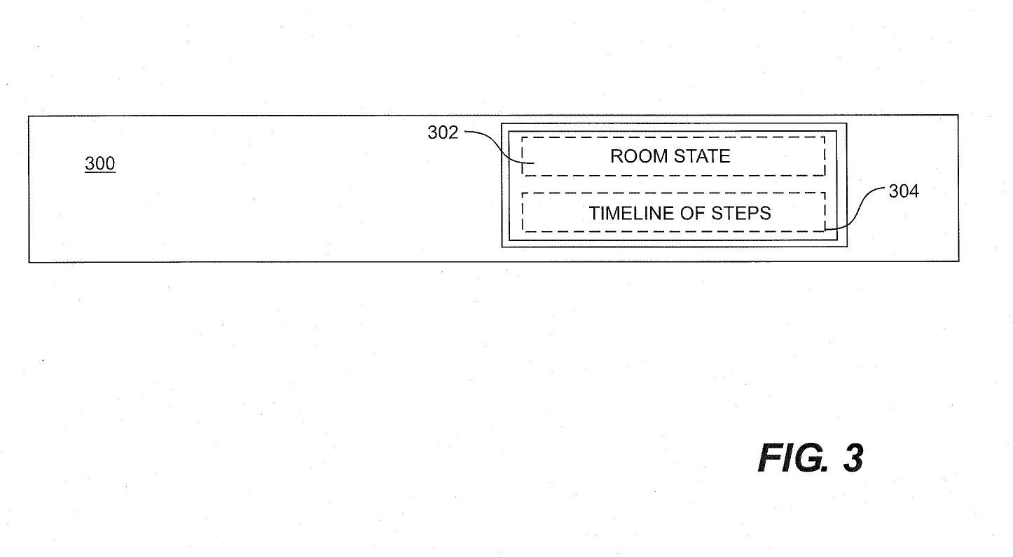

With reference now to FIG. 3, shown is an embodiment of a file 300 that records the state of the virtual room and is used by embodiments of systems and methods herein to recreate and restore a live presentation or meeting session. In embodiments, file 300 is saved with two (2) components as explained above and illustrated in FIG. 3:
State 302 of the room
A timeline 304 of steps

An example of a state 302 of the virtual room was provided above. Here, it is assumed that the presenter decides to start recording the session 20 minutes into the presentation when the virtual room is in that particular state 302. Presenter's client 104 sends a message to server 102 requesting that state 302 be saved. Server 102 first saves into the recorded file 300 the state object given above.

Server 102 then starts building a timeline 304 with all the steps occurring after recording is first requested by presenter. A timeline 304 has precise timing information as well as the associated step. As an example, the timeline 304 has a step at 5600 milliseconds into the presentation to change the slide from 5 to 6.

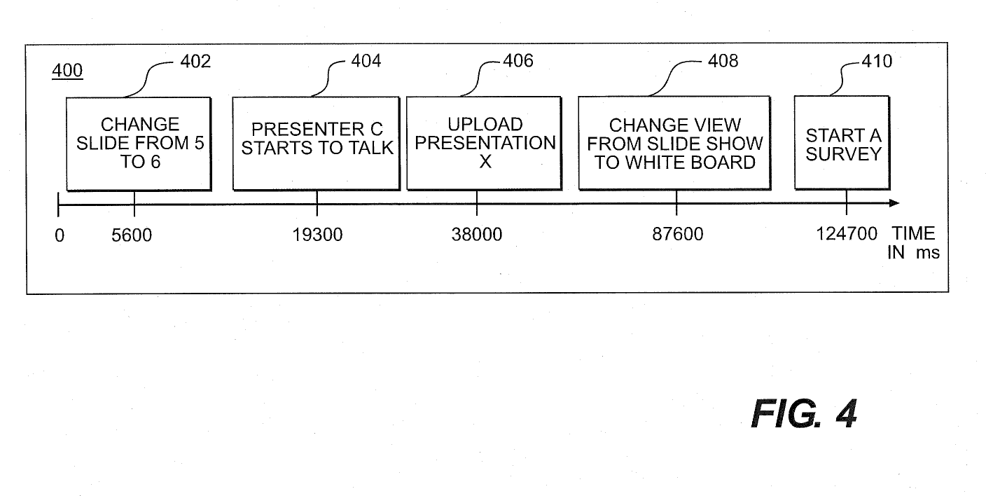

With reference now to FIG. 4, shown is an example of a timeline 304. Timeline includes, as noted above, timeline actions or step 402 of slide changing from 5 to 6, step 404 of presenter C starting to talk, step 406 of presentation being unloaded from clients 104, step 408 of changing virtual room view from presentation to white board, and step 410 of starting a survey. Each step 402-410 is recorded in timeline with time stamp of when step occurred. E.g., step 402 occurred at 5600 milliseconds since the beginning of the timeline. The steps may also include associated or supporting files and/or other materials.

When the presenter stops recording, the entire timeline is added to the recording file 300, as shown in FIG. 3. In reality there are many complex steps that involve more than changing a variable's value. An example is when a presenter starts to talk as shown on the timeline 304 illustrated in FIG. 4. When a person, e.g., a presenter at a client 104, starts to talk, server 102 records the step of the person beginning to talk by making a change to the profile of the person talking, since each person also has a state or ‘profile’. Moreover, in addition to recording the profile change, server 102 also needs to actually record the voice stream and save it into another ‘supporting’ file. For instance, if presenter C has a unique user identifier number 20876, then when the presenter C starts talking 404, server 102 also starts recording the voice stream into a file called 20876.str. Server 102 stops recording if the presenter stops talking or if the recording of the session is stopped

The example above shows that there are two types of steps to record a live web session in embodiments described herein:
Simple steps that record a room state change such as changing view from Slide Show to White Board.
Complex steps that have a supporting material that also needs to be recorded. Example: the stream of presenter C, 20876.str, record above when presenter C talks.

Among the types of complex steps are online polls or other requests for interactive responses from participants. For example, while conducting an online meeting or presentation, a presenter or person running the meeting may request participants respond to a question or respond to a poll. The question or poll may be related to the presentation or meeting topic. Supporting material that may be stored in conjunction with the question or poll may include a message containing the question or poll as well as the participant responses that are received.

As seen in the following section, Replay, the complex steps above are associated with the supporting material. Accordingly, when such complex steps are replayed, embodiments ask viewers to start playing the recorded supporting material, e.g., stream 20876.str. The replay success of such “complex steps” also depends on the successful replay of the supporting material.

Replay

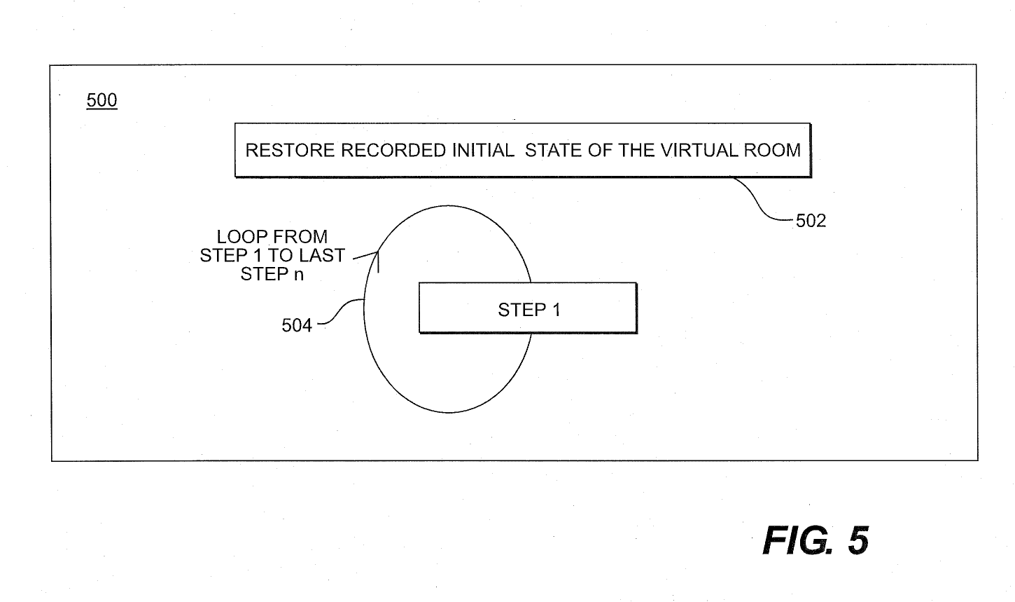

With reference now to FIG. 5, shown is the replay workflow 500 executed by embodiments of system and method for recreating and restoring a live online session. The recorded session can be replayed for a person in the “virtual room”—meaning connected to server 102—as if the recorded session was a live event. The recorded session can be replayed for one person only or for a group of people connected to conference server 102 with clients 104. The difference is that instead of a real presenter triggering activities, the steps or activities are initiated by following the recorded timeline 304. As an example, instead of a presenter sending a signal to server 102 to ask clients 104 to load presentation X, server 102 reads the initial virtual recorded room state 302, which says there is a presentation X at slide number 5, thereby causing server 102 to ask all participant clients 104 to load the presentation and go to slide 5.

In embodiments, the replay happens as well in two steps:
Read the virtual room state 302 from the recorded file 300 and restore the recorded virtual room state 302. This means updating the live virtual room state with the recorded virtual room state 302 and asking every client 104 connected to server 102 to comply with the new virtual room state 302.
Then start reading the timeline 304 based on the times saved in the file 300 and execute each step at the right time one by one until the end of the recording 300.

With reference again to FIG. 5, in replay workflow, embodiments restore the recorded initial state (room state 302) of the virtual room, block 502. Embodiments then loop through the steps i of the recorded timeline (timeline of steps 304) from step 1 of the recorded timeline through the last step, block 504. The following is a short pseudo-code example to achieve the Replay workflow illustrated in FIG. 5:

Function startReplay( )
{

initialState = readStateFromRecordedFile( );
timeline = readTimelineFromRecordedFile( );
restoreInitialState( );
playNextStep( );

}
Function playNextStep( )
{

stepObject = timeline [ stepCounter];
stepCounter++;
nextStepObject = timeline [ stepCounter];
execute(stepObject);
if (exists (nextStepObject)) // NOT THE END YET
{

deltaTime = nextStepObject.time − stepObject.time;
callLater (playNextStep, deltaTime); // CALL playNextStep
in deltaTime

seconds to play the next step

}

}

The embodiments described above recreate and restore the recorded presentation or meeting session exactly the way the session occurred live. For example, with reference again to FIG. 4, with the timeline 304 shown in FIG. 3, after restoring the initial virtual room state 302:
5.6 seconds after the beginning of the event, an attendee would see the slide show change to slide 6 (see step 402).
At time 19.3 seconds, the attendee would start hearing Presenter C (e.g., the server would send a message to attendee asking him/her to start playing the stream 20876.str) (see step 404).
At time 38 seconds, the presentation gets unloaded (removed from the client view) (see step 406)
At time 87.6 seconds the attendee view changes from Slide show to White Board (see step 408).
At time 124.7 seconds the server starts a survey. Note that a viewer can take the survey as if it was live (see step 410).

Fast Forwarding and Rewinding

Embodiments also provide a technique to fast forward or rewind while watching a recording.

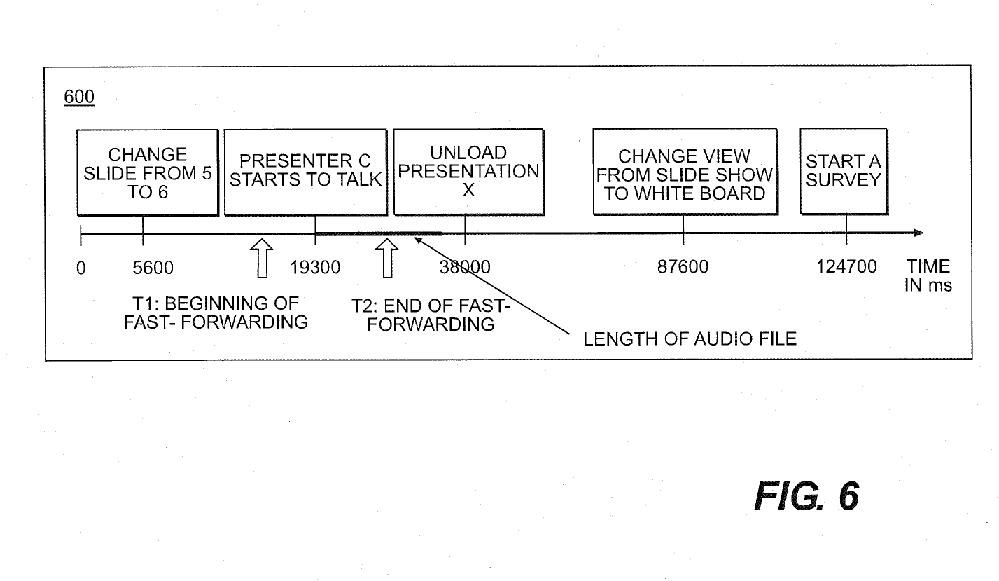

With reference now to FIG. 6, shown is a timeline 600 illustrating a method of fast-forwarding through a recorded session according to embodiments of system and method for recreating and restoring a live online session. Fast forwarding may be achieved by accelerating the execution of steps in the timeline 600. A viewer at a client 104 computer may execute a command that requests server 102 to fast-forward (or rewind) the recorded session. The command may be executed by moving the playback scrubber to the point the viewer wants to fast-forward (or rewind) to. If the viewer decides to fast-forward from time t1 to t2, server 102 executes all steps in between and ends up with a new room state, which it then pushes to the viewer's client 104 computer. The fast execution of steps can be challenging with ‘complex steps’ that have supporting materials. For example, a step signaling the beginning of a person talking has a recorded voice stream as its supporting material. When a fast forward is applied, depending on t2, server 102 may need to skip an entire audio file or start playing the audio file at a certain time. The timeline 600 shown in FIG. 6 illustrates such case in which a portion of the audio file is skipped so that the audio file is played starting from a certain time corresponding to the end of the fast-forwarding, t2.

In this case given that t2 is before the end of the audio file (presenter C talking), when the replay resumes at t2, server 102 calculates the offset in the audio file and instructs the viewer's client 104 computer to play the audio from that point on only instead of playing the audio file from the beginning. In the example above, the viewer's client 104 computer needs to start playing the audio file at approximately ¾ of its length.

Rewinding may be achieved through resetting the timeline to 0, then fast-forwarding to the requested time.

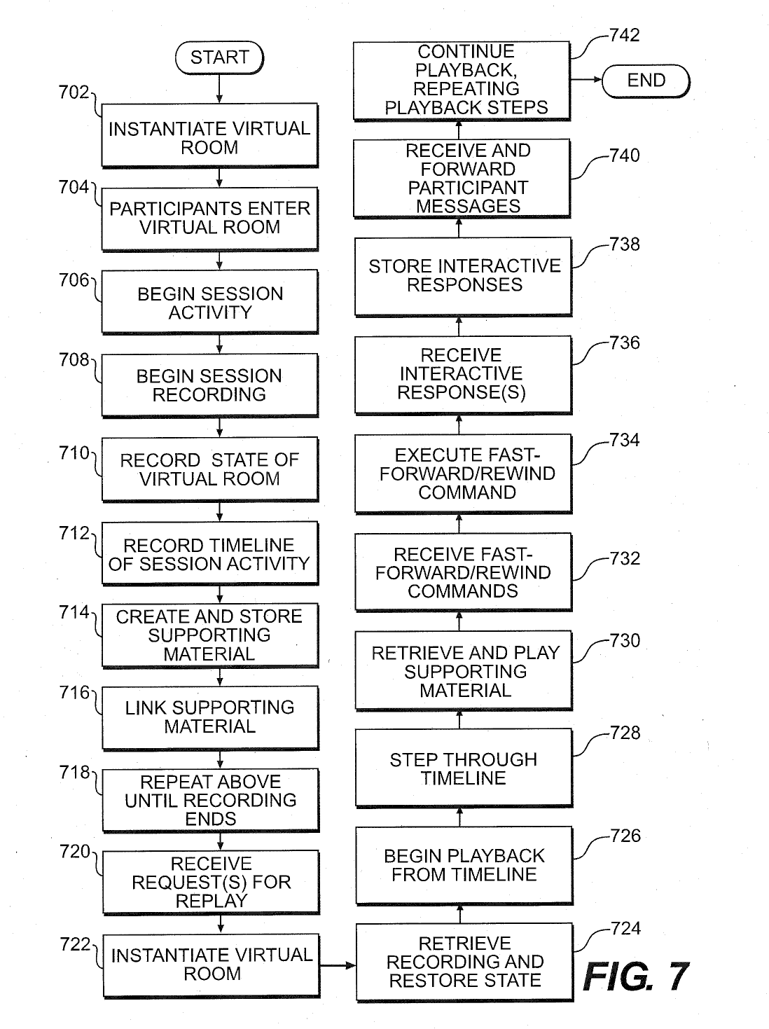

With reference now to FIG. 7, shown is a flowchart illustrating an embodiment of a method 700 for recreating and restoring a live online session. Method 700 ties together the above description to show the overall process of an embodiment of a method 700 for recreating and restoring a live online session. When an online presentation or meeting is to be held, a virtual room is instantiated, e.g., by server 102, block 702. Instantiating the virtual room begins the online session. One or more participants enter the virtual room and join the online session, block 704. Participants may enter the virtual room by clients 104 connecting with server 102 and logging in to or registering with virtual room (e.g., participant user at client 104 enters appropriate login or registration information). As noted above, a web conference session or ‘virtual room’ begins with the server authentication of participants, regrouped as presenters, moderators and attendees by a ‘gateway’ web server. Server receives authentication information, authenticates participants and connects clients 104 with virtual room. Once authenticated, the participants may be channeled to a different server, or remain on same server, which ‘hosts’ the live online session. Once a participant enters the virtual room and joins the online session, a window or other graphical interface to the virtual room may be displayed on client 104.

Once participants have joined, meeting, presentation, training session, or other activity, is started in virtual room, block 706. Online session activity may include a slide show, video, audio and/or some other media presentation shown on windows or other graphical interface and/or played through speaker devices of client 104. At some point during live online session, the recording of the live online session is begun, block 708. Typically, a session administrator (e.g., at a client 104 or other computer or terminal connected via a network or otherwise to server 102) will send a command to server 102 to begin the recording.

Once the recording begins 708, the state of the virtual room is recorded, block 710. Server 102 may record the state of the virtual room in a file, e.g., as described above. Recording 710 the state of the virtual room is a continuous process. In other words, the recorded state of the virtual room is constantly updated and recorded as it changes over time while the recording continues. Once the recording begins 708, a timeline is also recorded, block 712. As noted above, the timeline may include time-stamped steps corresponding to online session events and activities, e.g., changing of a slide in a slide show, a presenter speaking, a video starting, a slide show ending, etc. Multiple activities may overlap (e.g., a presenter may speak while a slide is changed in a slide show or a video starts).

Embodiments may detect beginning of event or activity by monitoring the state of virtual room and when events or activities occur that match certain criteria, e.g., audio is detected from presenter client 104 indicating presenter has begun to speak, embodiments may record such event or activity on timeline and in state of virtual room. In an embodiment, upon the start of recording 708, a global variable may be set so that functions, being executed on the server 102, can detect whether the server 102 is recording or not. For example, the global variable may be labeled “recording” and this variable may be set to true (recording=true) when server 102 is recording. If variable indicates server 102 is recording, functions may update recorded state and timeline when events or other activity occurs.

Furthermore, in embodiments, the server 102 has a number of functions to handle state and profile changes regardless of the recording state. Two examples of such functions are: changing image tab (which indicates to clients/participants that an image (such as a slide) should be changed—images may be displayed on image tab of GUI for virtual room 106) and presenter starting to talk (which indicates that a presenter/participant is beginning to talk) as shown in the pseudo-code below (these examples are represented without the recording process at this time):

Function onImageTabChange (newTab)
{

tellAllToChangeTab (newTab);

// Tells all web conference participants to change the // view
from one to another. Example: go from Slide
// Show view to White Board view

}
Function onSpeakingProfileChange(presenterID, newState)
{

Var newProfile = updateUserProfile(presenterID, newState);
pushNewProfileToAll(presenterID, newProfile);

}

In embodiments, server 102 is essentially a centralized system that receives a message from, e.g., a presenter 104, and propagates it to all connected participants/clients 104. When a presenter 104 changes an image tab from Slide Show to White Board on his/her computer, a message is received by the server 102 indicating the change and the function onImageTabChange above may be called with the information about the new image tab. Server 102 then sends the message to all other participants 710, who automatically switch to the new tab, e.g., White Board received from server 102 on their computers.

Similarly when a presenter 104 starts to talk (or activates his/her microphone) a message is sent to the server 102 and channeled to the function on SpeakingProfileChange with the presenterID, e.g., 20876, and the new state for the presenter's user profile, e.g., true for speaking and false if stopped speaking. The on SpeakingProfileChange function then updates the profile of the presenter on the server and communicates it to all participants 104. If the state is ‘true’, then participants' client software 104 starts playing the voice stream (e.g., 20876.str) received from the server 102.

With continuing reference to FIG. 7, each such event or activity may include an associated or supporting file. Accordingly, method 700 may create and store supporting file for activity, block 714, and link supporting file to timeline (to timeline activity (e.g., to beginning of event “presenter C starts to talk”), block 716. Server 102 may record the supporting file in a local database or other storage location. When session activities or events begin or occur, embodiments may determine that such activities or events match certain criteria that indicate the activities or events need a supporting file (e.g., event is presenter beginning to speak, hence, a supporting audio file is needed). When such a determination is made, supporting file is created and stored 714 and linked 716 to timeline.

It is noteworthy that the two example functions given above provide an example of a simple step as well as an example of a complex step. Changing of the image tab from Slide Show to White Board as an example does not require any supporting media for the participant 104 (assuming slide show and white board previously sent to participants 104) while the profile change to speaking necessitates the playing of a media file, e.g., the voice stream, on the participant 104 side.

Accordingly, in embodiments of system and method for recreating and restoring a live online session, the functions above may be modified as follows:

Function onImageTabChange(newTab)
{

If (recording)
{

recordStateChange(TABCHANGETYPE, newTab);
// calls function to save the state change into
// timeline.
// Type of change: TABCHANGE
// Value: newTab e.g White Board

}
tellAllToChangeTab(newTab);

// Tells all web conference participants to change the // view
from one to another. Example: go from Slide
// Show view to White Board view

}
Function onSpeakingProfileChange(presenterID, newState)
{

Var newProfile = updateUserProfile(presenterID, newState);
If (recording)
{

recordProfileChange(presenterID, newProfile);
// calls function to save the new profile into
// timeline.
If (newState) // if true, meaning started to talk

recordVoiceStream(presenterID);

else // stopped talking

stopRecordingVoiceStream(presenterID);

}
pushNewProfileToAll(presenterID, newProfile);

}

In the second function, on SpeakingProfileChange, if global variable indicates server 102 is recording, e.g., recording=true, embodiments record the voice stream (supporting media) in addition to recording the profile change into the timeline. As a consequence at the time of replay, viewer 104 will receive a message to play the stream 20876.str from the recorded media as opposed to the live stream.

With complex steps such as the one handled by on SpeakingProfileChange there may be two cases when it comes to the recording process:

a) Recording starts before the step

b) Recording starts after the step

Case a) is managed by the function above. This means that once recording=true and the function on SpeakingProfileChange is called, the on SpeakingProfileChange function knows how to handle the recording. However case b) is not handled by the on SpeakingProfileChange function since recording starts potentially minutes after the call to the on SpeakingProfileChange function.

In embodiments of system and method for recreating and restoring a live online session, case b) may be handled when the server 102 saves the state 302 at the very beginning of the recording process. At that time, saving a complex state also entails saving the corresponding media.

As an example, if recording while Presenter C (presenterID 80765) is talking (his/her microphone is already active), one of the initial state 302 items is a profile of the user with presenterID 80765 has speaking=true. In that case server 102 may call on SpeakingProfileChange(20876, true) manually so the voice streams gets recorded. The pseudo-code function below shows how the recording of the initial state 302 handles recording of associated media.

Function recordInitialState( )
{

Loop through roomStateObject : state S
{

addToState(S);
// Adds S to the list of initial state
If (hasMedia(S))

RecordMedia(S);
// If corresponding media, start saving media

}
Loop through users profiles: profile P
{

addToState(P);
// Adds P to the list of initial state
If (isSpeaking(P))

onSpeakingProfileChange(P.userID, true);
// start saving the voice stream if speaking

...

}

}

Method 700 repeats the above recording steps 710 to 716 until the online session ends or the recording is stopped, block 718. When session ends or recording is otherwise stopped, recorded state and timeline are saved, block 720. As noted above, timeline and state information may be saved in one recording file. Server 102 may save recording file in local database or other storage location.

With continuing reference to FIG. 7, at some point after or during the live online session, one or more playback participants connect with server 102 and request a replay or restoration of the live online session. Method 700 receives the request or requests for replay of the recorded online session, block 722. The request may include an identifier identifying the desired recorded online session. A participant may send the request via client 104 to server 102. Upon receiving 722 the request, server 102 may instantiate virtual room, beginning an online session, block 724. Embodiments may then retrieve recording file for appropriate saved session and restore state of virtual room per the saved state in the recording file, block 726. After restoring the state, embodiments may begin playback of the online session from the recorded timeline, block 728. Embodiments step through timeline, block 730, retrieving and playing/executing stored supporting files, block 732, as necessary.

While stepping through 730 timeline, server 102 may receive fast-forward or rewind commands, block 734. Such commands may be sent by participant from client 104 as described above. Embodiments may execute fast-forward or rewind commands, block 736, accelerating through steps in timeline to the requested position. Embodiments may also fast-forward or rewind through supporting files as appropriate and as described above.

With continuing reference to FIG. 7, as noted above, an online session may also include interactive responses from participants. Such interactivity may be recorded in the recording file and included on the timeline as an event. For example, a presenter or person running an online meeting may ask a question(s) or request responses to a poll related to the meeting or presentation topic. Such a question or poll request may be stored as an event on the timeline. During the playback of the online session, the same question or poll request may be asked of the playback participants. Accordingly, method 700 may include receiving interactive responses from playback participant(s), block 738, and storing interactive responses, block 740. The playback participant interactive responses may optionally cause results from the live online session to be adjusted. For example, if playback participants are requested to respond to a poll, their responses may optionally be added to the poll responses from the live online session and the poll results adjusted accordingly. Likewise, if there is a group (e.g., a plurality) of playback participants reviewing the playback together, the playback participants may exchange messages with each other. Server 102 may receive and forward such playback participant messages, block 742, and may store such messages for later review by the presenter.

Method 700 continues playback of online session, stepping through timeline, retrieving and playing/executing stored supporting files, fast-forwarding and/or rewinding, until recorded session is completed or playback is ended, block 744.

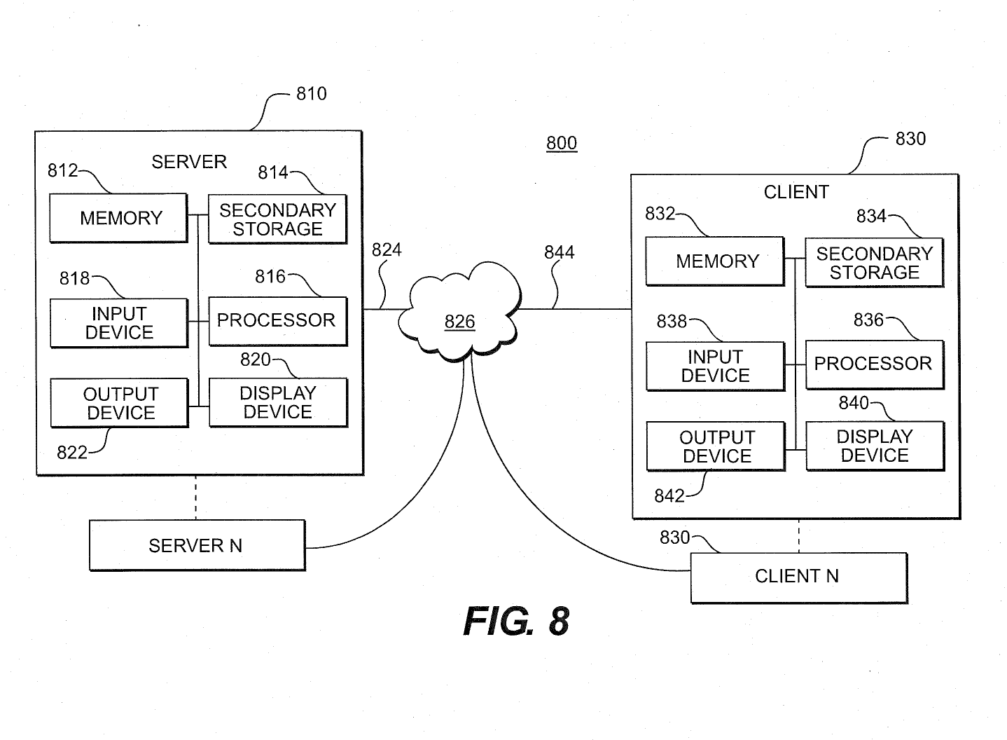

With reference now to FIG. 8, shown is a block diagram illustrating exemplary hardware components for implementing an embodiment of system 800 for recreating and restoring a live online session. As shown in FIG. 1 discussed above, system 800 may includes a plurality of clients 830 (corresponding to clients 104) connected with a network 826 such as the Internet, providing a network connection for participating in online sessions and replayed online sessions. Presenters, administrators and other users participating or needing access to virtual rooms and the online sessions may also use clients 830 or similar machines.

Participants at clients 830 interact with server 810, i.e., conference server 102, to access virtual room, participate in online sessions and to review record and restored online sessions. Server 810 provides and maintains the virtual room, the recording file, and a network connection to application(s) through which the above steps are preformed. System 800 may also include the ability to access one or more web site servers (not shown) in order to obtain content from the World Wide Web, if desired.

Client 830 illustrates typical components of a client 104 computer. Client 830 typically includes a memory 832, a secondary storage device 834, a processor 836, an input device 838, a display device 840, and an output device 842. Memory 832 may include random access memory (RAM) or similar types of memory, and it may store one or more applications, and a web browser, for execution by processor 836. Secondary storage device 834 may include a hard disk drive, floppy disk drive, CD-ROM drive, or other types of non-volatile data storage. Processor 836 may execute applications or programs stored in memory 832 or secondary storage 834, or received from server 810 via the Internet or other network 826, and the processing may be implemented in software, such as software modules, for execution by computers or other machines. These applications preferably include instructions executable to perform the methods described above and illustrated in the FIGS. herein. The applications preferably provide graphical user interfaces (GUIs) through which participants may view and interact with the virtual rooms and online sessions.

Input device 838 may include any device for entering information into client 830, such as a keyboard, mouse, cursor-control device, touch-screen, microphone, digital camera, video recorder or camcorder. The input device 838 may be used to enter information into GUIs during performance of the methods described above. Display device 840 may include any type of device for presenting visual information such as, for example, a computer monitor or flat-screen display. The display device 840 may display the GUIs, including virtual room GUI, described above. Output device 842 may include any type of device for presenting a hard copy of information, such as a printer, and other types of output devices include speakers or any device for providing information in audio form.

Examples of clients 830 for interacting with server 810 include personal computers, laptop computers, notebook computers, palm top computers, network computers, or any processor-controlled device capable of executing a web browser or other type of application for interacting with the system.

Server 810 typically includes a memory 812, a secondary storage device 814, and a processor 816. Server 810 may include a plurality of processors 816 and be configured as a plurality of, e.g., bladed servers, or other known server configurations. Server 810 may also include an input device 818, a display device 820, and an output device 822, although these may exist in a terminal for directly accessing server 810. Memory 812 may include RAM or similar types of memory, and it may store one or more applications for execution by processor 816. Secondary storage device 814 may include a hard disk drive, floppy disk drive, CD-ROM drive, or other types of non-volatile data storage. Processor 816 executes the application(s) which are stored in memory 812 or secondary storage 814, or received from the Internet or other network 826.

Server 810 may store a database structure in secondary storage 814, for example, for storing and maintaining information regarding the online sessions and the methods described herein. For example, it may maintain a relational or object-oriented database for storing information about online sessions, recorded sessions, and other information necessary to perform the above described methods. Such information may also include information necessary for participant authentication

Also, processor 816 may execute one or more software applications in order to provide the functions described in this specification, specifically to execute and perform the steps and functions in the methods described above. Such methods and the processing may be implemented in software, such as software modules, for execution by computers or other machines. The processing may provide and support the virtual rooms described in this specification and otherwise for display on display devices associated with the clients 830. The GUIs may be formatted, for example, as web pages in HyperText Markup Language (HTML), Extensible Markup Language (XML) or in any other suitable form for presentation on a display device depending upon applications used by users to interact with the system 800.

The GUIs preferably include various sections, to provide information or to receive information or commands. The term “section” with respect to GUIs refers to a particular portion of a GUI, possibly including the entire GUI. Sections are selected, for example, to enter information or commands or to retrieve information or access other GUIs. The selection may occur, for example, by using a cursor-control device to “click on” or “double click on” the section; alternatively, sections may be selected by entering a series of key-strokes or in other ways such as through voice commands or use of a touch screen.

Although only one server 810 is shown in detail, system 800 may use multiple servers as necessary or desired to support the users and may also use back-up or redundant servers to prevent network downtime in the event of a failure of a particular server. In addition, although client 830 and server 810 are depicted with various components, one skilled in the art will appreciate that these machines and the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, such as client 830 and server 810, to perform a particular method, such as methods described above.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for restoring and recreating a live, on-line session, comprising:
instantiating a virtual room on a server for an on-line session, wherein one or more participating client computers may connect to the server and enter the virtual room to participate in the on-line session;
retrieving a recording of an original on-line session, wherein the recording includes a recorded state and a recorded timeline of events of the original on-line session;
restoring the recorded state of the original on-line session, wherein the restoring sets a state of the virtual room to the recorded state of the original on-line session;
beginning playback of the recorded timeline of events;
stepping through the recorded timeline of events;
receiving interactive responses to events on the recorded timeline of events, wherein the receiving receives interactive responses from the one or more participating client computers; and
storing the interactive responses.

2. The method of claim 1 wherein the timeline of events include a survey event and the receiving receives responses to the survey event.

3. The method of claim 2 wherein the storing the interactive responses includes optionally updating the survey event with the interactive responses so that the survey event includes a survey result based on the interactive responses and responses to the survey event received during the original on-line session.

4. The method of claim 1 wherein the storing the interactive responses includes optionally updating responses, from the original on-line session, to the events.

5. The method of claim 1 wherein the restoring sets the state of the virtual room to a state from after the beginning of the original on-line session.

6. The method of claim 1 wherein the retrieved recording includes a plurality of states of the original on-line session corresponding to different times on the recorded timeline of events.

7. The method of claim 1 wherein the recorded timeline of events includes links to supporting material, the method further comprising:
retrieving supporting material; and
playing the retrieved supporting material.

8. The method of claim 7 wherein the playing the retrieved supporting material transmits the retrieved supporting material to the one or more participating client computers for playback.

9. The method of claim 7 wherein the playing the retrieved supporting material displays the retrieved supporting material in the virtual room.

10. The method of claim 7 wherein the supporting material includes a media file.

11. The method of claim 1 wherein the restoring includes starting a slide presentation program, wherein slides are displayed on the one or more participating client computers.

12. The method of claim 1 further comprising:
receiving fast forward command; and
fast-forwarding through recorded timeline of events.

13. The method of claim 1 further comprising:
receiving rewind command; and
rewinding through recorded timeline of events.

14. The method of claim 1 wherein a plurality of participating client computers connect to the server and enter the virtual room to participate in the on-line session, the method further comprising:
receiving a message from one of the participating client computers; and
forwarding the message to the plurality of participating client computers.

15. The method of claim 1 wherein the original on-line session was a presentation.

16. The method of claim 1 wherein the original on-line session was a meeting.

17. The method of claim 1 further comprising receiving a request for a replay of the original on-line session.

18. A method for restoring and recreating a live, on-line session, comprising:
instantiating a virtual room on a server for an original on-line session, wherein one or more participating client computers may connect to the server and enter the virtual room to participate in the original on-line session;
beginning the on-line session activity;
recording the on-line session activity, wherein the recording creates a recording of the on-line session;
closing the virtual room for the original on-line session;
receiving a request for a replay of the original on-line session;
in response to the received request, instantiating a virtual room on a server for a restored on-line session, wherein one or more participating client computers may connect to the server and enter the virtual room to participate in the restored on-line session;
retrieving the recording of the original on-line session, wherein the recording includes a recorded state and a recorded timeline of events of the original on-line session;
restoring the recorded state of the original on-line session, wherein the restoring sets a state of the virtual room to the recorded state of the original on-line session;
beginning playback of the recorded timeline of events;
stepping through the recorded timeline of events;
receiving interactive responses to events on the recorded timeline of events, wherein the receiving receives interactive responses from the one or more participating client computers; and
storing the interactive responses.

19. A computer readable medium comprising instructions for restoring and recreating a live, on-line session by:
instantiating a virtual room on a server for an on-line session, wherein one or more participating client computers may connect to the server and enter the virtual room to participate in the on-line session;
retrieving a recording of an original on-line session, wherein the recording includes a recorded state and a recorded timeline of events of the original on-line session;
restoring the recorded state of the original on-line session, wherein the restoring sets a state of the virtual room to the recorded state of the original on-line session;
beginning playback of the recorded timeline of events;
stepping through the recorded timeline of events;
receiving interactive responses to events on the recorded timeline of events, wherein the receiving receives interactive responses from the one or more participating client computers; and
storing the interactive responses.

20. A system for restoring and recreating a live, on-line session comprising:
a server computer, comprising one or more memories and one or more processors, wherein the one or more memories includes instructions executed by the one or more processors for restoring and recreating a live, on-line session by:
instantiating a virtual room on a server for an on-line session, wherein one or more participating client computers may connect to the server and enter the virtual room to participate in the on-line session;
retrieving a recording of an original on-line session, wherein the recording includes a recorded state and a recorded timeline of events of the original on-line session;
restoring the recorded state of the original on-line session, wherein the restoring sets a state of the virtual room to the recorded state of the original on-line session;
beginning playback of the recorded timeline of events;
stepping through the recorded timeline of events;
receiving interactive responses to events on the recorded timeline of events, wherein the receiving receives interactive responses from the one or more participating client computers; and
storing the interactive responses.
